(19) United States
(12) Patent Application Publication
(10) Pub. No.: US 2020/0368765 A1
(43) Pub. Date: Nov. 26, 2020

(54) NOZZLE DEVICE FOR A FLUID, METHOD FOR PRODUCING A NOZZLE DEVICE AND KIT COMPRISING A ROTOR AND A HOLLOW NEEDLE FOR A NOZZLE DEVICE

(71) Applicant: MVT Micro-Verschleiss-Technik AG, Port (CH)

(72) Inventors: Attila SCHÜTZ, Evilard (CH); Yves GNÄGI, Bellmund (CH)

(21) Appl. No.: 16/764,060

(22) PCT Filed: Nov. 8, 2018
(86) PCT No.: PCT/EP2018/080563

§ 371 Date: May 14, 2020

(30) Foreign Application Priority Data
Nov. 17, 2017 (CH) 01399/17

(51) Int. Cl. B05B 3/04; B05B 15/18

(52) U.S. Cl. CPC B05B 3/0427; B05B 3/006; B05B 15/18

(57) ABSTRACT

A nozzle device (1) for a fluid which comprises a stator (2), which has at least one connection (3) for a fluid line (4), a rotor (5) which is mounted in the stator (2) so as to be rotatable about a rotational axis (A) and has an axial, preferably continuous channel (6), a nozzle carrier (8) for at least one nozzle (9) arranged on a first end (7) of the rotor (6), and comprising a hollow needle (10) which has a continuous passage (11) and is arranged in the channel (6) of the rotor (5) such that the fluid can be conveyed from the fluid line (3) as far as the nozzle carrier (8). According to the invention, the hollow needle (10) is held on the stator (2) so as to be rotationally fixed.

The invention relates to a nozzle device for a fluid as per the preamble of the independent claim. The invention also relates to a method for producing a nozzle device according to the invention, and to a kit comprising a hollow shaft and a hollow needle for a nozzle device according to the invention.

Nozzle devices of the type mentioned in the introduction are used in particular for the cleaning of surfaces and for the removal of material.

Such a nozzle device comprises a stator having at least one connection for a fluid line. The connected fluid line is generally a high-pressure or extreme-pressure fluid line. In the stator, there is arranged a rotor which is mounted so as to be rotatable about an axis of rotation and has an axial duct, wherein a nozzle carrier for at least one nozzle is arranged on a first end of the rotor. Here, the duct is preferably formed to be continuous.

The at least one nozzle is arranged on the nozzle carrier such that the fluid which flows through the duct generates swirl when flowing out of the nozzle and the rotor is thereby set in rotation.

A problem with known nozzle devices is the sealing of the components, since the fluid pressures are above 3000 bar and moreover some components rotate. What is very difficult in particular is the sealing of the rotor, especially of the duct, with respect to the components which are static during operation.

Various solutions are therefore proposed. Some of these work with conventional shaft seals, which, however, owing to the high rotational speeds and the resulting friction, become worn very quickly and have to be replaced at regular intervals.

Other solutions provide for the arrangement of sleeves in the duct of the rotor, which form a labyrinth seal. Although such solutions are satisfactory with regard to the sealing properties, they also have to be maintained at regular intervals, wherein the number of the components to be replaced is greater in comparison with nozzle devices having conventional shaft seals. The material costs and the maintenance outlay are accordingly higher.

It is therefore an object of the present invention to specify a nozzle device of the type mentioned in the introduction which avoids the disadvantages of the known nozzle devices and, in particular, has improved sealing properties and a longer service life and is less maintenance-intensive.

The object is achieved by way of a nozzle device as per the independent claim.

As already mentioned in the introduction, a nozzle device comprises a stator having at least one connection for a fluid line. The connected fluid line is generally a high-pressure or extreme-pressure fluid line. In the stator, there is arranged a rotor which is mounted so as to be rotatable about an axis of rotation and has an axial duct, wherein a nozzle carrier for at least one nozzle is arranged on a first end of the rotor that faces away from the connection for the fluid line. Here, the duct is preferably formed to be continuous.

A hollow needle having a continuous passage is arranged in the duct of the rotor such that the fluid is able to be conducted from the fluid line to the nozzle carrier. The hollow needle is thus arranged in the duct so as to be coaxial with the rotor.

According to the invention, the hollow needle is held in a rotationally fixed manner against the stator.

The fastening of the hollow needle to the stator, with the rotor being rotatable about the hollow needle, results in the sealing between the hollow needle and the rotor being realized as a gap ring and, consequently, very good sealing properties being achieved.

This is the case in particular if the hollow needle extends substantially over the entire axial length of the duct of the rotor.

Optimum sealing action owing to the length of the hollow needle is advantageous here. Moreover, such a configuration is simple to construct and, in comparison with known solutions from the prior art, exhibits little wear.

Preferably, at least one outer surface of the hollow needle consists of a highly wear-resistant material. The highly wear-resistant material is preferably a DLC (diamond-like carbon) coating, which is applied by chemical vapor deposition (CVD) or physical vapor deposition (PVD).

Consequently, not only is the service life of the hollow shaft increased, but also any friction of the outer surface of the hollow needle with the fluid or with a cylindrical surface of the duct is minimized.

Preferably, the hollow needle is held against the stator by means of a union nut.

A fastening with a union nut has, for a suitable selection of the thread, very good sealing properties. Moreover, a large contact pressure force can be generated by the union nut.

In particular, the union nut is provided with an outer thread section and has a central passage bore through which the hollow shaft is able to be inserted. The hollow shaft accordingly preferably has projections or preferably has a projecting annular surface against which the union nut is stopped, and in this way the hollow needle can be pressed against the stator.

Preferably, the hollow needle has at one end a head with a frustoconical head surface.

A frustoconical head surface allows very good sealing properties if it interacts with a correspondingly shaped mating surface, this being described in more detail below.

Here, the stator preferably has a frustoconical surface against which the frustoconical head surface of the hollow needle is supported. The frustoconical head surface of the hollow needle and the frustoconical surface of the stator are in this case preferably formed in a complementary manner.

In this way, a centering effect for the hollow needle is additionally ensured. Also in this way, self-locking of the connection between the hollow needle and the stator can be generated. It may also be provided that the cone angle of the stator differs slightly from the cone angle of the head surface.

It is preferable in this case for the cone angle of the frustoconical head surface of the hollow needle to be smaller than the cone angle of the frustoconical surface. This results in the achievement of a point support, which ensures particularly good sealing. In the case of high-pressure and extreme-pressure applications, generally the cone angle on the stator is 60° in size and the cone angle of the complementary surface (the cone angle of the hollow needle, in the invention) is 58° in size.

This also generates clamping of the hollow needle against the stator, in particular if the hollow needle is then pressed against the stator by way of a union nut.

The hollow needle is preferably received in the duct of the rotor without any appreciable play (according to SN EN 20286-2). This means that the hollow needle is received in the duct with a very low fit tolerance.

In particular, the hollow needle, with an outer diameter, and the diameter of the duct of the rotor are realized with a fit H7/g6 according to the standard bore system according to SN EN 20286-2, which allows a fit tolerance zone of between 4 μm and 24 μm in the nominal size range of over 3 mm to 6 mm.

The fit H7/g6 is preferably maintained if the nominal size range of the standard bore is less than or equal to 3 mm or is greater than 6 mm.

Preferably, the duct of the rotor has a concentricity of at most 0.03 mm, in particular at most 0.02 mm, with respect to the axis of rotation.

The duct is preferably produced using a deep drilling process and preferably has a roughness Ra (average roughness value) of at most 0.4 μm.

Preferably, the hollow needle is paired with the rotor.

The hollow needle is paired with the rotor to ensure an optimal fit.

Here, the pairing is preferably realized during the production of the duct, which is machined repeatedly until the minimum value of the fit tolerance zone for the selected fit is reached. For example, for the aforementioned fit H7/g6 according to the standard bore system in the nominal size range of over 3 mm to 6 mm, the hollow needle is paired with a rotor such that the tolerance amounts to 4 μm, which corresponds to an annular gap size of 2 μm. For a smaller duct (nominal size range of up to 3 mm), the annular gap would be 1 μm in size, and for a larger duct (nominal size range of over 6 mm to 10 mm, for example), the annular gap would be 2.5 μm in size.

The object is furthermore achieved by way of a method as per the method claim.

The embodiments and advantages described above in relation to the nozzle device are correspondingly applicable to the method according to the invention.

The method according to the invention comprises the step of pairing a rotor with a hollow needle.

The object is furthermore achieved by way of a kit as per the kit claim.

The possibility of replacing and retrofitting nozzle devices is made possible in a simple way with a kit comprising a rotor according to the invention and a paired hollow needle, wherein the step of pairing takes place already at the factory and a user merely has to install into the existing nozzle device/replace the rotor with the hollow needle.

The embodiments and advantages described above in relation to the nozzle device are correspondingly applicable to the kit according to the invention.

The kit according to the invention comprises a rotor and a hollow needle, which have been paired.

The invention will be described in more detail below on the basis of a preferred exemplary embodiment and in conjunction with the figures. In the figures:

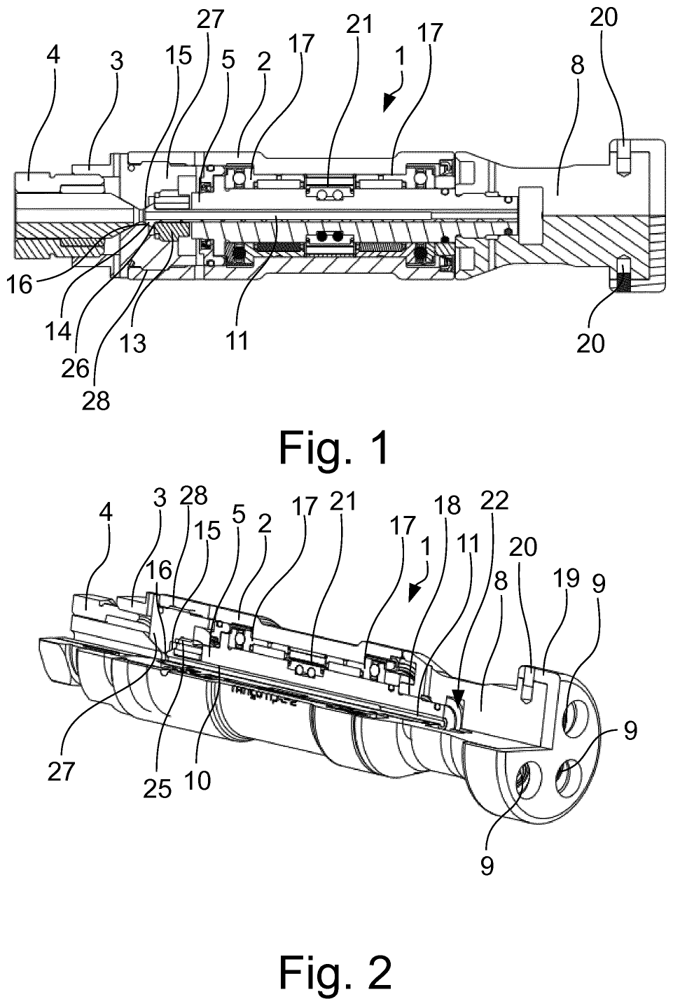

FIG. 1 shows an axial sectional view through a nozzle device according to the invention;

FIG. 2 shows a perspective view, partially cut out, of the nozzle device in FIG. 1;

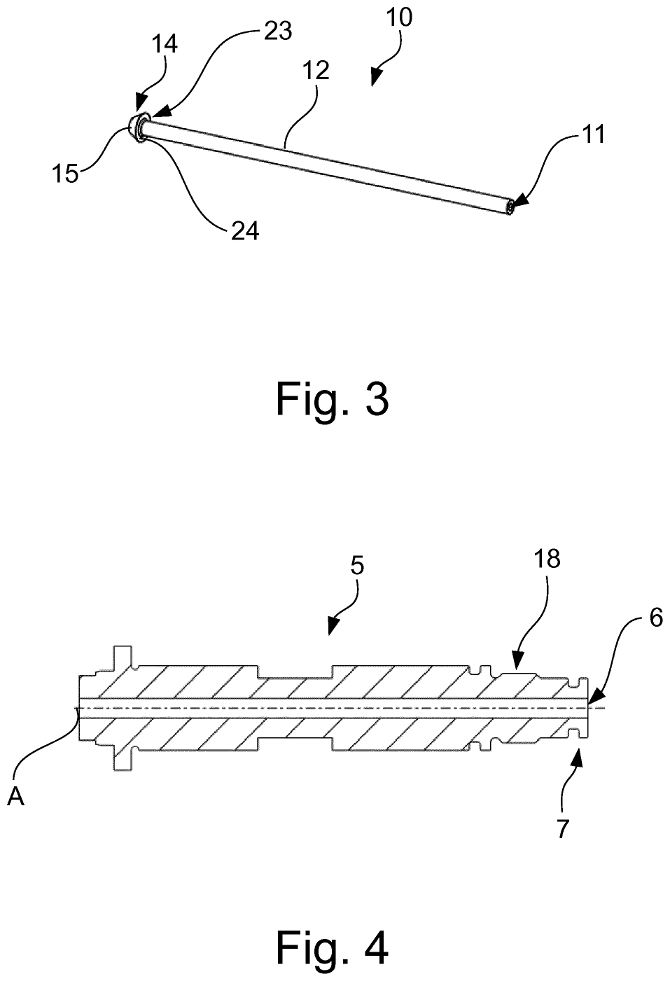

FIG. 3 shows a perspective view of the hollow needle according to the invention;

FIG. 4 shows an axial sectional view through the rotor according to the invention; and

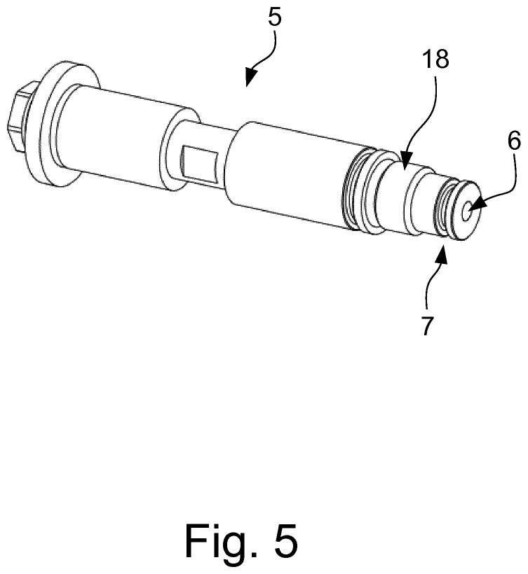

FIG. 5 shows a perspective view of the rotor in FIG. 4.

FIGS. 1 and 2 show a nozzle device 1 according to the invention. FIGS. 3 or 4 and 5 show details of the hollow needle 10 and of the rotor 5.

The nozzle device 1 comprises a stator, which is generally provided with the reference sign 2. The stator 2 may however be of multi-part design and comprise further components, which, for the sake of clarity, if not necessary, are always referred to as the stator 2.

The stator 2 is of hollow design and serves as a housing for further components of the nozzle device 1. The stator 2 has a connection 3 for a fluid line 4, said connections being standardized and known per se to a person skilled in the art.

A rotor 5 having an axial, continuous duct 6 is arranged in the stator 2. The rotor 5, by means of needle axial ball bearings 17, is mounted in the stator 2 so as to be rotatable about an axis of rotation A. A nozzle carrier 8 is fastened to that end 7 of the rotor 5 which faces away from the connection 3. The fastening of the nozzle carrier 8 to the rotor 5 is realized via a screw connection 18, wherein the outer thread of the rotor is denoted by the reference sign 18 in FIGS. 4 and 5. It goes without saying that, according to the direction of rotation of the rotor, the screw connection 18 (and further screw connections described later) are always designed such that the screw connection 18 is tightened by the rotation of the nozzle carrier 8 or of the rotor 5.

In the nozzle carrier 8, there are arranged 4 nozzles 9, of which merely 3 can be seen in FIG. 2 owing to the cutout. The nozzles 9 are arranged such that the exiting fluid generates swirl and sets in rotation the rotor 5 together with the nozzle carrier 8. A protective cap 19 is fastened to the nozzle carrier 8 by means of threaded screws, of which merely the bores 20 can be seen.

In order to control the rotational speed of the rotor 5 in operation, an eddy current brake 21 is arranged in the stator 2.

In the duct 6 of the rotor 5, which can be seen in FIGS. 4 and 5, there is arranged a hollow needle 10, illustrated separately in FIG. 3, which extends over the entire length of the duct 5. The hollow needle 10 has an axial passage 11 through which the fluid can flow from the fluid line 4 to the nozzle carrier 8 and which opens into a distribution chamber 22 of the nozzle carrier 8. The distribution chamber 22 is connected in a fluid-conducting manner to in each case one nozzle 9 via lines (not illustrated) such that the fluid can flow out of the nozzle device.

From FIG. 3, it can be seen that the hollow needle 10 has a cylindrical outer surface 12, which is provided with a highly wear-resistant and low-friction coating. At the end facing the connection 3, the hollow needle 10 has a head 14 with a frustoconical head surface 15. The head 14 also has a projection 23 with a stop surface 24 at the transition to the outer surface 12.

The head surface 15 is supported against a frustoconical surface 16 of the stator 2, as illustrated in FIGS. 1 and 2. A union nut 13 with an outer thread 25 is in a state fitted onto the hollow needle 10 and is screwed firmly to the stator 2 via the outer thread 25. In this case, the stop surface 24 is stopped against an end surface 26 of the union nut 13 and the frustoconical head surface 15 of the hollow needle 10 is pressed against the frustoconical surface 16 of the stator 2. The hollow needle 10 is thereby firstly centered and secondly, by way of self-locking of both frustoconical surfaces 14 and 16 and by way of the contact pressure force, is held in a rotationally fixed manner against the stator 2.

For the purpose of simplified assembly, the stator 2 comprises a fastening section 27 which is designed to receive the union nut 13 and which is fastened via a thread 28 to the rest of the stator 2.

The hollow needle 10 is received in the duct 5 without any appreciable play. The low fit tolerance and the length of the hollow needle 10, which extends over the entire length of the duct 6, makes it possible for the rotating components to be sealed off with respect to the static components without the need for resorting to high-wear parts such as seals. The shaft seals shown in the figures prevent bearing lubricating grease from escaping.

Owing to the highly wear-resistant coating of the outer surface 12 of the hollow needle 10, the service life of the hollow needle 10 and of the rotor 5 is increased. Moreover, depending on the gap size between the outer surface 12 and the duct 6, the hollow needle 10 can act as a slide bearing and additionally stabilize the rotor 5, wherein the fluid flowing in the passage 11 can possibly effect cooling of the hollow needle 10 and of the rotor 5.

1-10. (canceled)

11. A nozzle device for a fluid, comprising:
a stator which has at least one connection for a fluid line,
a rotor which is mounted in the stator so as to be rotatable about an axis of rotation and has an axial duct,
wherein a nozzle carrier for at least one nozzle is arranged on a first end of the rotor, and
a hollow needle has a continuous passage and is arranged in the duct of the rotor such that the fluid is able to be conducted from the fluid line to the nozzle carrier, and
the hollow needle is held in a rotationally fixed manner against the stator.

12. The nozzle device as claimed in claim 11, wherein the axial duct is continuous.

13. The nozzle device as claimed in claim 11, wherein the hollow needle extends substantially over an entire axial length of the duct of the rotor.

14. The nozzle device as claimed in claim 11, wherein at least one outer surface of the hollow needle comprises a wear-resistant material.

15. The nozzle device as claimed in claim 14, wherein the wear-resistant material is a DLC coating.

16. The nozzle device as claimed in claim 11, wherein the hollow needle is held against the stator by a union nut.

17. The nozzle device as claimed in claim 11, wherein the hollow needle has a head, at one end, with a frustoconical head surface.

18. The nozzle device as claimed in claim 17, wherein the stator has a frustoconical surface against which the frustoconical head surface of the hollow needle is supported.

19. The nozzle device as claimed in claim 11, wherein the hollow needle is received in the duct of the rotor without any appreciable play.

20. The nozzle device as claimed in claim 19, wherein the hollow needle and the rotor are paired such that an annular gap size, between the duct and the outer surface of the hollow needle, is at most half a minimum value of a fit tolerance zone of a selected fit.

21. A method of producing a nozzle device as claimed in claim 11, comprising the step of:
pairing a rotor with a hollow needle.

22. A kit comprising a rotor and a paired hollow needle for a nozzle device as claimed in claim 11.
